(19) United States
(12) Patent Application Publication
(10) Pub. No.: US 2020/0125973 A1
(43) Pub. Date: Apr. 23, 2020

(54) Data Centre Utilisation Forecasting System And Method

(71) Applicant: University of Leeds, Leeds (GB)

(72) Inventors: Paul Michael Townend, Wakefield (GB); Jie Xu, New Castle (GB); Ismael Solis Moreno, Queretaro (MX)

(21) Appl. No.: 16/627,220

(22) PCT Filed: Jul. 11, 2018
(86) PCT No.: PCT/GB2018/051964

§ 371 Date: Dec. 27, 2019

(30) Foreign Application Priority Data
Jul. 12, 2017 (GB) 1711223.6

(51) Int. Cl. G06N 5/04; G06N 20/00

(52) U.S. Cl. CPC G06N 5/04; G06N 20/00

(57) ABSTRACT

A data centre utilisation forecasting system (200), comprises a behavioural profiler (210) configured to determine a plurality of data centre virtual behaviour patterns from data centre utilisation information and a data centre utilisation predictor (220) configured to calculate at least one data centre utilisation metric based on the determined data centre virtual behaviour patterns, data centre policy information and/or infrastructure data representing hardware and/or software components of a data centre. Accordingly, a utilisation forecast is provided that takes into account not only the physical infrastructure of the data centre, but also virtual behaviour patterns.

### FIELD

The present invention relates to a data centre utilisation forecasting system. The present invention further relates to a method of forecasting data centre utilisation.

### BACKGROUND

The data centres that support modern IT, for example by providing cloud computing resource, acting as co-location centres, or providing massive amounts of storage, are extremely complex systems of systems. The infrastructure of such data centres comprises a huge number of interacting components, including physical components (e.g. computational hardware, networking hardware, power distribution systems, and cooling systems), software components (e.g. virtualisation software, scheduling software, networking software, security software, monitoring software, as well as the software executed as part of user-specified tasks or jobs), as well as business process components (e.g. service-level agreements, quality of service policies, and security policies).

FIG. 1 shows a schematic representation of the components of a typical data centre 100, including exemplary physical components 110, power management components 120, virtual/software components 130 and business processes 140. It will be apparent that myriad interactions occur between each of the components 110-140 (and their respective subcomponents), leading to a great deal of complexity.

Accordingly, difficulties arise when changes are made to the composition of the data centre 100—for example by changing or upgrading components or by changing relevant policies—in that the overall effect of the change cannot be easily calculated because of the complex interactions involved. The potential for unforeseen consequences, coupled with the business-critical nature of data centres, leads to unnecessarily conservative design choices. Consequently, the average utilisation of a typical data centre is as low as 10%, leading to a considerable amount of wasted resource, poor energy efficiency and unnecessary capital and operational expenditure.

In order to attempt to forecast the result of changes made to the data centre infrastructure, the majority of data centre operators use spread sheets to manually forecast and manage their facilities, or use predictive DCIM (data centre infrastructure management) tools that monitor and forecast based on only the physical characteristics of the data centre.

For example, in one prior art method, supervised machine learning is employed to forecast data centre performance, by representing the physical characteristics of entire existing data centres as single data points represented by feature vectors. Example features may include the number of CPUs, amount of RAM, amount of disk storage and so on. Accordingly, an appropriate amount of required physical resources may be predicted for a given workload. However, such modelling is relatively coarse-grained and does not take into account the complex interactions described above.

It is an aim of the invention to overcome the disadvantages outlined above, and any other disadvantages that will be apparent to the skilled reader from the description herein. It is a further aim of the invention to provide accurate means of forecasting the impact of infrastructure change on a data centre.

### SUMMARY

According to the present invention there is provided an apparatus and method as set forth in the appended claims. Other features of the invention will be apparent from the dependent claims, and the description which follows.

According to a first aspect of the invention there is provided a data centre utilisation forecasting system, comprising:

a behavioural profiler configured to determine a plurality of data centre virtual behaviour patterns, from data centre utilisation information; and

a data centre utilisation predictor configured to calculate at least one data centre utilisation metric based on the determined data centre virtual behaviour patterns, data centre policy information and/or infrastructure data representing hardware and/or software components of a data centre.

Each virtual behaviour pattern may represent the behaviour of a subset of one or more of: servers of the data centre; software tasks running in the data centre, or users of the data centre.

The data centre utilisation information may comprise a data centre trace log. The data centre utilisation information may comprise data relating to one or more of: compute element utilisation, memory utilisation, cooling utilisation, disk utilisation, power consumption, and/or heat generation. The compute element may comprise one or more of a central processing unit (CPU), graphics processing unit (GPU), Field-Programmable Gate Array (FPGA). The data centre information may comprise data regarding one or more tasks submitted by one or more users. The data centre information may comprise data relating to resources requested by each user for each task, and preferably an actual amount of resource that was actually required to complete each task. The data centre information may comprise a length of time required to complete each task.

The data centre utilisation information may comprise information captured over a sliding time window prior to the present time.

The behavioural profiler may be configured to determine the data centre virtual behaviour patterns using machine learning, preferably unsupervised machine learning.

The behavioural profiler may be configured to determine the data centre virtual behaviour patterns using machine learning by clustering one or more of the servers, the software tasks or the users. The behavioural profiler may be configured to use K-means clustering. The behavioural profiler may be configured to select an optimal number of clusters by clustering for a plurality of values of k, and selecting the value of k in which a variability of the clusters is below a predetermined threshold.

The behavioural profiler may calculate one or more features to represent each server, task or user of the data centre utilisation information. The features may include a submission rate, representing the number of tasks submitted by a user, preferably in a predetermined time period, for example per hour or per 5 minutes. The features may include a requested amount of compute element per task, and/or a requested amount of memory per task. A task may be represented by one or more of a length of execution, a compute element utilisation and a memory utilisation.

The behavioural profiler may be operable to periodically determine the plurality of data centre virtual behaviour patterns.

The utilisation predictor may comprise an environment generator, configured to generate simulated components of a simulated datacentre based on data centre policy information and/or infrastructure data. The infrastructure data may include information of simulated physical components of the simulated data centre, preferably including one or more of: a number of servers and an amount of compute element and memory per server, physical distribution data, and cooling data. The infrastructure data may comprise power system data, preferably including one or more of power availability data, back-up system data, and energy efficiency data. The infrastructure data may comprise virtual and software data, preferably including server virtualisation data. The data centre policy information may include scheduling policies. The data centre policy information and/or infrastructure data may be defined recursively, so that elements of data centre policy information and/or infrastructure data can be defined at varying levels of detail.

The environment generator may be configured to generate a simulated workload for the data centre, preferably by generating users and/or tasks and/or servers based on the behaviour patterns. The simulated workload may be generated based on one or more probability distributions. The environment generator may be configured to determine the probability distributions based on the data centre utilisation information.

The utilisation predictor may comprise a simulation engine, configured to execute the simulated workload on the simulated components. The simulation engine may comprise a scheduler operable to schedule the simulated workload, preferably using a bin-packing algorithm.

The utilisation predictor may comprise a monitoring unit operable to collect data from the simulated data centre and generate the at least one data centre utilisation metric based on the collected data. The monitoring unit may comprise one or more monitoring elements, each monitoring element being comprised in a simulated component of the simulated data centre. The at least one data centre utilisation metric may be one or more of: energy consumption data, energy efficiency data, resource utilisation and allocation per server, event timestamps and resource request and utilisation per task.

According to a second aspect of the invention there is provided a computer-implemented method of forecasting data centre utilisation, comprising:

determining a plurality of virtual behaviour patterns by analysing data centre utilisation information;

specifying infrastructure data representing hardware and/or software components of a data centre; and

calculating at least one data centre utilisation metric based on the determined virtual behaviour patterns, data centre policy information and/or the infrastructure data.

Further preferred features of the method of the second aspect are defined hereinabove in relation to the system of first aspect, and may be combined in any combination.

According to a third aspect of the invention there is provided a computer-readable medium having instructions recorded thereon which, when executed, cause a computing device to perform the method defined in the second aspect.

The computer-readable medium may be non-transitory. Further preferred features of the computer-readable medium of the third aspect are defined hereinabove in relation to the system of first aspect, and may be combined in any combination.

According to a fourth aspect of the invention there is provided a computer program product comprising computer program code for causing a computing device to perform the method defined in the second aspect.

Further preferred features of the computer program product of the fourth aspect are defined hereinabove in relation to the system of first aspect, and may be combined in any combination.

The invention also extends to a computer device including at least a memory and a processor configured to perform any of the methods discussed herein.

### BRIEF DESCRIPTION OF DRAWINGS

For a better understanding of the invention, and to show how embodiments of the same may be carried into effect, reference will now be made, by way of example, to the accompanying diagrammatic drawings in which:

FIG. 1 is a schematic block diagram illustrating the components of a typical data centre;

FIG. 2 is a schematic block diagram of an example data centre utilisation forecasting system;

FIG. 3 is a schematic block diagram of the utilisation predictor of the data centre utilisation forecasting system of FIG. 2;

FIG. 4 is a schematic block diagram of a part of the scheduling engine of the utilisation predictor of FIG. 3;

FIG. 5 is a flowchart representing the lifecycle of an exemplary task defined in the data centre utilisation forecasting system of FIGS. 2-4; and

FIG. 6 is a flowchart illustrating an exemplary method of scheduling a task the scheduling engine of the utilisation predictor of FIG. 3.

In the drawings, corresponding reference numerals indicate corresponding components. The skilled person will appreciate that elements in the figures are illustrated for simplicity and clarity. For example, common but well-understood elements that are useful or necessary in a commercially feasible embodiment are often not depicted in order to facilitate a less obstructed view of these various example embodiments.

### DESCRIPTION OF EMBODIMENTS

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly.

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In overview, embodiments of the invention provide a means of forecasting data centre utilisation by modelling data centre behaviour patterns. Particularly, data centre information (e.g. for example historical information such as trace logs) is used to categorise or cluster virtual behaviour patterns—i.e. the behaviour patterns of one or more of users, data centre servers, software tasks and so on. Taking into account these models of virtual data centre behaviour enables the system to provide accurate forecasts of the impact of infrastructure change or changes in data centre customer base.

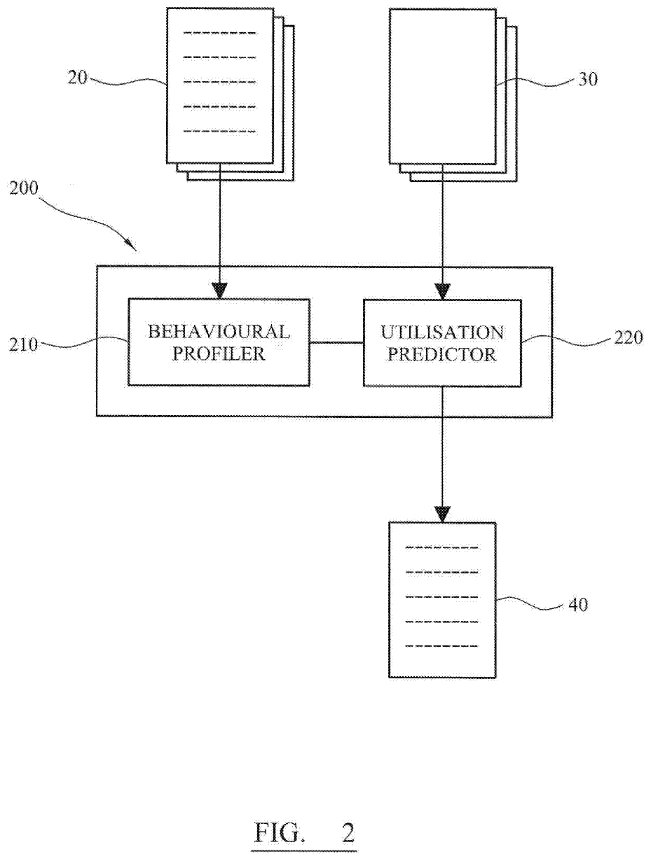

FIG. 2 shows an example data centre utilisation forecasting system 200. The system comprises a behavioural profiler 210 and a utilisation predictor 220.

The behavioural profiler 210 is configured to analyse data centre utilisation information 20, and determine a plurality of virtual behaviour patterns.

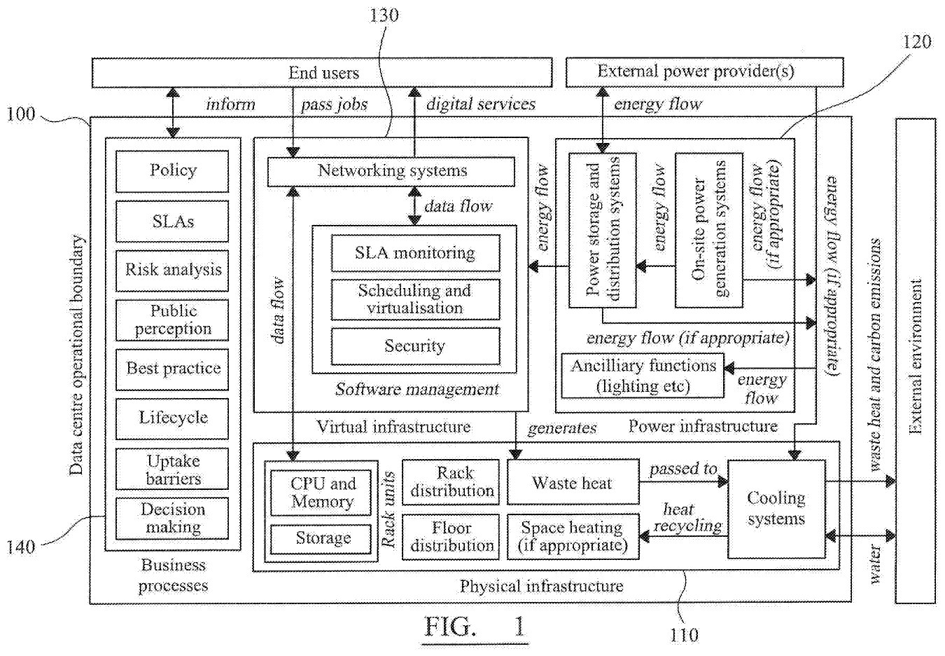

In one example, the data centre utilisation information comprises a set of readings derived from the log data generated by the components of a data centre, hereinafter referred to as a trace log. These readings are generated from the various components 110-140 and their respective subcomponents, as shown in the system model shown in FIG. 1. It will be appreciated that different components provide different parameters/readings in the log data. For example, the power-related components 120 provide data relating to power consumption. The physical components 110 may provide information regarding heat generation, cooling usage, CPU utilisation, and memory utilisation and so on. In addition, the trace log comprises details of which users submit tasks to the data centre at what time. For the jobs that are submitted, the trace log comprises details of the resources requested by the user for the task, and along with the amount of resource (e.g. CPU, memory) that was actually required to complete the task, along with the length of time required to complete the task.

It will be understood that the above-mentioned parameters are merely a selection of the parameters that could form the data centre utilisation information 20, and that the exact parameters present in the information 20 will depend on the components present in the data centre.

It will be understood that examples of the invention may be arranged to forecast the utilisation of data centres that comprise heterogeneous computing systems, in which compute elements other than CPUs (Central Processing Units) are used in addition to, or instead of, CPUs. For example, the compute elements may comprise Graphics Processing Units (GPUs), Field-programmable gate arrays (FPGAs) and the like. In such examples, the references herein to CPU utilisation should be construed to encompass the utilisation of other compute elements.

In one example, the behavioural profiler 210 is operable to determine the virtual behaviour patterns from a sliding window of time over the data centre utilisation information 20—i.e. based on predetermined time period back from the present time. For example, historical information from the last week, month, or year. Accordingly, the data centre utilisation information 20 may encompass very recent historical data—for example only a few seconds or minutes old.

It will be understood that the size of sliding window may be altered based on user needs and/or in line with the customer base and types of tasks typically submitted to the data centre. For example, in a data centre with a relatively stable user-base submitting similar tasks over a long time period, it may be appropriate to take into account a relatively long period of historical data centre utilisation information 20. Conversely, in a data centre with a rapidly-changing user-base, a shorter window may be more advantageous.

The behavioural profiler 210 is operable to categorise one or more of the users, servers, tasks and other elements of the data centre based on the virtual behaviour patterns that can be observed from the information 20. The behavioural profiler 210 is configured to categorise the users/servers/tasks/etc. based on their behaviour, so as to identify and quantify the number of users/servers/tasks/etc. acting in a certain way. For example, with respect to users, one category may represent users that submit large tasks (i.e. tasks that require large amounts of CPU/memory) irregularly. Other categories may represent users that submit small tasks regularly, users that significantly over-estimate the resource required to carry out the tasks they submit, and so on.

In one example, the behavioural profiler 210 uses unsupervised machine learning techniques to cluster the data derived from the data centre utilisation information 20. Accordingly, the number of categories to be derived is not predetermined, but is instead determined automatically from the data centre utilisation information 20 itself.

In one example, the K-means clustering algorithm is employed, which divides n observations from the data into k clusters. Accordingly, each user/server/task/etc. (i.e. each observation) is represented by a selection of features relating to it calculated from the data centre utilisation information 20, and the data is portioned by being grouped around cluster centroids.

In one example, k is selected using the method outlined in Pham et al (D. T. Pham, S. S. Dimov, C. D. Nguyen, “Selection of K in K-means clustering”, Proc. Inst. Mech. Eng. Part C: J. Mech. Eng. Sci., vol. 219, pp. 103-119, 2005.). Particularly, the K-means algorithm is run for k ranging from 1 to 10. For each value of k the function ƒ(k) is calculated, which represents the variability of the clusters that have been derived. An optimal k is selected based on ƒ(k)—for example k is selected when ƒ(k)≤0.85. This ensures the number of clusters is derived in a formal, quantitative manner, without introducing subjectivity.

In further example, other unsupervised or supervised machine learning techniques could be employed to categorise the behaviours.

In addition to users, servers and tasks, virtual behaviours may also be determined in respect of jobs, racks (i.e. an apparatus retaining a plurality of servers) and virtual machines/containers.

In terms of the features representing the users/servers/tasks, three features have been found to be important:

Submission rate. This is the quotient of dividing the number of submissions (i.e. software tasks sent to the data centre) by the time span of a trace log, and is presented as task submissions per hour.

Requested amount of CPU per submission. Represented as normalised resources requested by users taken directly from the task events log within a trace log.

Requested amount of Memory per submission. Represented as normalised resources requested by users taken directly from the task events log within a trace log.

Tasks themselves are defined by the by the type and amount of work dictated by users, resulting in different execution length and resource utilization patterns. Consequently, in one example, the key parameters that describe tasks are the length and the average resource utilisation for CPU and Memory. Length is defined as the total amount of work to be computed, and the average resource utilization is the mean of all the consumption measurements recorded in the trace log for each task.

Accordingly, the behavioural profiler 210 is operable to determine virtual behaviour patterns for each of the users, servers, tasks and other virtual behaviours in the data centre information 210, and provide this information to the utilisation predictor 220.

In one example, the behaviour profiler 210 is operable to carry out the determination of the virtual behaviour periodically. For example, the virtual behaviour may be determined once a day, once a week or once a month. Accordingly, the behavioural profiler 210 is operable to determine the virtual behaviour patterns with a level of regularity that ensures changes in virtual behaviour are captured, so that the data centre utilisation forecasting system 200 can make more accurate forecasts.

It will be appreciated that the regularity of the periodic determination may be altered based on user needs and/or in line with the customer base and types of tasks typically submitted to the data centre. For example, in a data centre with a relatively stable user-base submitting similar tasks over a long time period, it may not be necessary to re-determine the patterns as regularly as in a data centre with a rapidly-changing user-base.

The utilisation predictor 220 is a data centre simulator that is operable to generate a data centre utilisation forecast 40 based on the determined behaviour patterns, and data centre component data 30.

To accurately forecast data centre behaviour, each component in the system is simulated using realistic parameters based on empirical values generated in the real system. The outputs from one component are then fed into the inputs of other components based on the relationships specified in the system model.

For example, users (i.e. customers) pass software tasks into the data centre. By looking at real user behaviour, a simulation is generated that represents a realistic flow of jobs into the networking systems component of the model. This component will send information to, among other things, the scheduling and virtualisation component of the system. Based on the scheduling policy of the data centre in question, this component will send information back to the networking systems component, dividing and scheduling a job into a series of tasks. Tasks will then be sent from the networking systems” component to the CPU and Memory component. This will place virtual load on the CPU/Memory in question, based on the type of job being passed. This virtual load will be sent to the waste heat component, which will calculate the amount of heat generated by the CPU/Memory based on this load. This information will then be sent to the Cooling systems component, and will feedback heat to the CPU/memory, as heat may affect performance. Accordingly, an accurately simulated data centre is modelled.

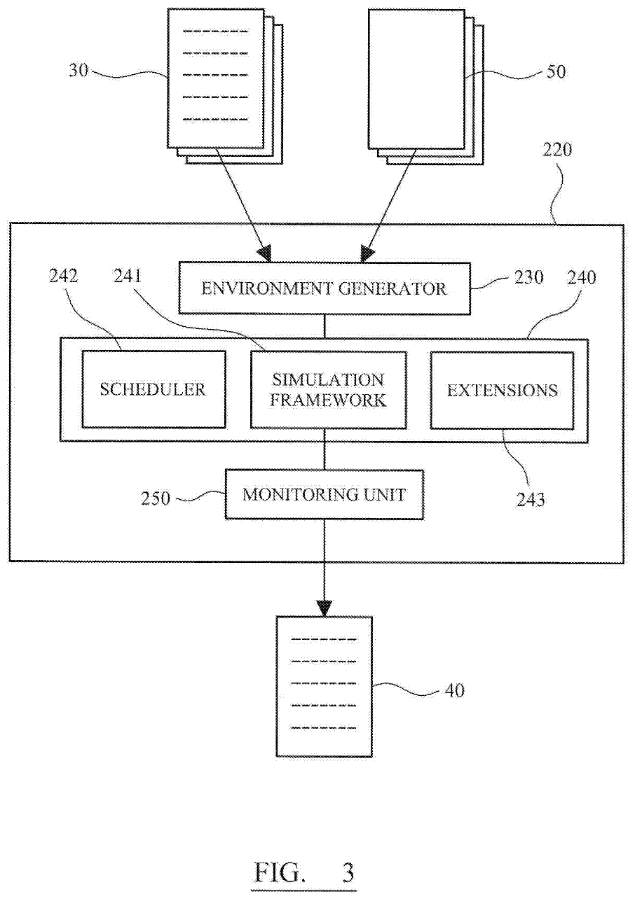

The components of the utilisation predictor 220 are shown in more detail in FIG. 3.

The utilisation predictor 220 comprises an environment generator 230, a simulation engine 240, and a monitoring unit 250.

The environment generator 230 creates the simulated components of the data centre in the memory of the system 200, based on the data centre component data 30. The data 30 effectively specifies the make up of the data centre that is being simulated, for example by specifying the features of the components shown in FIG. 1.

In other words, the component data 30 may include information on physical components 110, such as the number of servers and their respective amounts of CPU and memory, how they are physically distributed, how they are cooled and so on. It may further include information on the power management components 120—e.g. the amount of power available, the presence of back-up systems, the energy efficiency and so on. It may further include information regarding the virtual/software components, including the networking configuration, and server virtualisation configuration. It may further include information on any applicable business process components 140, such as relevant policies (e.g. scheduling policies) that affect the usage of the data centre.

Supplying the component data 30 in line with the model shown in FIG. 1 allows the relative components to be defined in a recursive fashion. In other words, each component of the model can be defined at a high level (i.e. with a group of components represented by one larger components), or at a lower level (i.e. a component is broken down into a set of further components).

The environment generator 230 is further operable to generate a simulated workload for the data centre, by generating users, tasks and servers in each of the categories established by the behavioural profiler 210. In one example, the number of each user/task/server of each category that is generated is determined by probability distributions 50, which specify the likelihood of a user/task/server being generated.

The probability distributions 50 may be determined by the behavioural profiler 210. For example, the probability distributions are derived based on the data centre utilisation information, e.g. by using the relative size of each category to determine its relative probability.

In one example, the environment generator 230 operable to determine the probability distributions 50 based on a sliding window of time over the data centre utilisation information 20—i.e. based on predetermined time period back from the present time. For example, information from the last week, month, or year. Accordingly, the data centre utilisation information 20 may encompass very recent data—for example only a few seconds or minutes old.

In a further example, the probability distributions 50 are set manually. Accordingly, the data centre operator can modify the probabilities so as to forecast the effect of changes in use base, task type/submission rate and so on.

Accordingly, the environment generator 230 generates the underlying simulated data centre infrastructure, and generates the simulated workload the data centre runs.

The simulation engine 240 is configured to carry out the simulation. In one example, the simulation engine 240 comprises a simulation framework 241, which implements the core elements of the simulation (i.e. users/tasks/servers), and a plurality of component extensions 243, which extend the definition of the original core elements.

In one example, the simulation framework 241 is the CloudSim framework (http://www.cloudbus.org/cloudsim/). The component extension 243 extends the customer (i.e. user), task, server and data centre elements present in the existing simulation engine 241, by providing further functionality so as to more accurately simulate the data centre. The components of this module 243 substitute the core elements of the CloudSim framework 241 during the environment generation and the simulation execution. They provide extended characteristics and functionality according to the parameters and patterns obtained during the analysis and characterization.

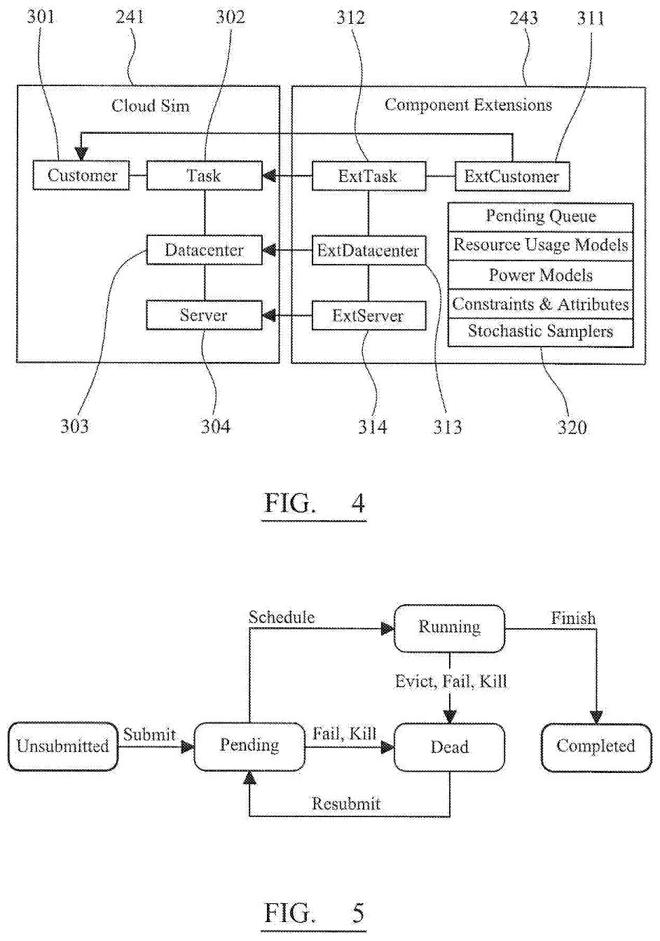

For example, as can be seen in FIG. 4, the user element 301, task element 302, data centre element 303 and server element 304 of the simulation framework 241 are extended by corresponding elements 311-314 of the component extensions 243.

Furthermore, a set of different supporting components 320 are created to simulate elements such as the pending queue, resource request and utilization models, and stochastic generators based on modelled distributions.

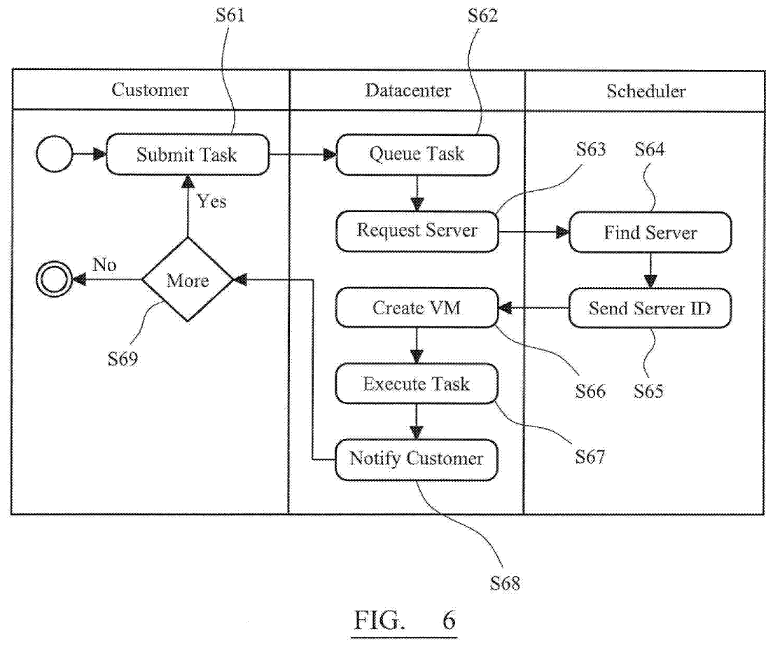

In one example, extended task element 312 implement a model of the life cycle of a task, in which tasks can pass through four different states: Pending, Running, Dead and Completed, which are driven by a set of events that includes task submissions and re-submissions, failures, evictions, and killing as presented in FIG. 5, and as outlined in C Reiss, et al., “Google Cluster-usage Traces: Format+Schema”, Google Inc., White Paper, 2011. A task will be assigned Pending status when it is initially submitted by the customer and re-submitted by the scheduler 243, which is described further below.

Once the scheduler 243 finds a suitable server to allocate the task and it is deployed, the status is changed to Running. An individual task can only be Running within a single server at any time. In addition, it is possible for a task to be rescheduled to another server. When a task is Running it can be move to Dead state when evicted, killed or fails and to Completed state when is successfully finished. If a task is evicted, fails or is killed it remains runnable and it is automatically re-submitted.

Returning to FIG. 3, the scheduler 242 of the simulation engine 240 implements the scheduling algorithm used by the data centre. In one example, the scheduling algorithm is a bin-packing algorithm. The scheduler 242 interacts with the extended elements 311-314, 320 every time a task is submitted or resubmitted in order to find a suitable server to host the task. The scheduler 242 receives from the data centre element 303/313 the resources requested by the user/customer as well as a list of placement constraints, and returns the unique identifier of the selected server 304/314 to which the task is to be allocated. Subsequently, the data centre element 303/313 is responsible for creating a virtual machine (VM) in the identified server 304/314 and starting the execution of the task.

The interaction of the elements during task scheduling is illustrated in FIG. 6. It can be seen therefrom that the user/customer 301/311 submits a task (S61), which is then placed in a pending queue of the data centre element 303/313 to be allocated (S62). Subsequently, a server is requested (S63) and the scheduler 242 finds a suitable server to carry out the task as outlined above (S64), and returns the unique identifier of the selected server (S65). Next, a VM is created in the allocated server (S66) and the task is executed therein (S67). On completion of the task, the user is notified (S68), at which point either a next task is submitted or the process ends (S69).

In one example, the scheduler 242 also provides interfaces to integrate diverse allocation policies into the simulation framework in order to evaluate different allocation solutions.

It will be understood that in further examples the simulation framework 241 may be based on other data centre simulation frameworks, e.g. one or more of Haizea, SPECI, GreenCloud, DCSim, iCanCloud. In further examples, the simulation engine 241 may be a custom-developed simulation engine 241. In such an example, the engine 241 may comprise the functionality of the extensions 243.

The monitoring unit 250 is configured to monitor the data centre simulation executed by the simulation engine 240, and capture data that provides the utilisation forecast 40. In one example, the monitoring unit 250 comprises a set of monitoring elements that are embedded into the data centre and server elements, which collect data and generate log files. Exemplary data captured includes data regarding energy consumption, resource utilisation and allocation per server, event timestamps and resource request and utilisation per task. Accordingly, the captured data provides metrics by which the performance of the simulated data centre can be measured.

Exemplary metrics include one or more of:

CPU loads, wherein each process using or waiting for CPU increments the load number by 1;

temperatures, including degrees Celsius or Fahrenheit per node, per rack or over the whole data centre;

cooling costs, for example calculated by multiplying the required cooling power by the unit price of the required power;

throughput, which is the number of jobs completed in a predetermined time period, and energy efficiency metrics, for example power usage effectiveness (PUE).

Similarly to the scheduler 242, the monitoring unit 250 allows the integration of diverse logging elements into the data centre components to capture the required data for various types of analysis.

In use, data centre utilisation data 20 is provided to the behavioural profiler 210. The profiler 210 analyses the data 20, clustering users, servers, tasks and other elements (e.g. racks, jobs, etc.) present in the data 20 to derive a set of categories representing common behaviours of the users, servers, tasks and other elements.

Subsequently, data centre component data 30 is provided to the utilisation predictor 220. Based on the data centre component data 30, a simulated data centre is created in memory by the environment generator 230. Tasks are created by the environment generator 230 based on the categories derived by the profiler, and executed by simulation engine 240.

When the simulation is complete, the log data generated by the monitoring unit 250 provides one or more metrics indicating the utilisation of the simulated data centre.

In order to assess the future impact of any change to the data centre (e.g. more or fewer servers, extra CPU or memory resource, upgraded networking infrastructure, changes in power management, changes in allocation policy, and so on), changes are made to the data centre component data 30 and the simulation is repeated. Equally, the probability distributions 50 that control the generation of simulated tasks/users/servers/etc. may be altered, to provide insight into the performance of the data centre in the event that different quantities of each category of tasks/users/servers are present. Accordingly, an empirical assessment can be made of the impact of the changes.

Advantageously, the above-described systems and methods produce utilisation forecasts that take into account not only the physical infrastructure of the data centre, but also virtual behaviour. Accordingly, the utilisation forecasts more accurately reflect the highly complex system-of-systems that is present in typical data centres.

The modelling of behaviour advantageously allows what-if predictions regarding changes in user base or user behaviour. Accordingly, a data centre operator can accurately predict the extra resource required to deal with a large new customer, or equally determine what the impact of losing a customer will be on the operation of the data centre.

Advantageously, the provision of accurate forecasting ensures empirical (and less conservative) choices can be made in terms of data centre scheduling policy and capacity planning, thereby avoiding wasted resource and improving energy efficiency.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A data centre utilisation forecasting system, comprising:
a behavioural profiler configured to determine a plurality of data centre virtual behaviour patterns from data centre utilisation information; and
a data centre utilisation predictor configured to calculate at least one data centre utilisation metric based on the determined data centre virtual behaviour patterns, data centre policy information and/or infrastructure data representing hardware and/or software components of a data centre.

2. The system of claim 1, wherein each data centre virtual behaviour pattern represents the behaviour of a subset of one or more of:
servers of the data centre;
software tasks running in the data centre;
users of the data centre;
jobs comprising a plurality of software tasks running in the data centre;
racks comprising a plurality of servers; or
virtual machines or containers.

3. The system of claim 1, wherein the data centre utilisation information comprises a data centre trace log.

4. The system of claim 1, wherein the data centre utilisation information comprises data relating to one or more of: compute element utilisation, memory utilisation, disk utilisation, cooling utilisation, power consumption, and/or heat generation.

5. The system of claim 1, wherein the data centre utilisation information comprises data regarding one or more tasks submitted by one or more users, data relating to resources requested by each user for each task, and an actual amount of resource that was actually required to complete each task.

6. The system of claim 1, wherein the behavioural profiler is configured to determine the data centre virtual behaviour patterns by clustering one or more of the servers, the software tasks or the users.

7. The system of claim 6, wherein the behavioural profiler is configured to select an optimal number of clusters by clustering for a plurality of values of k, and to select the value of k in which a variability of the clusters is below a predetermined threshold.

8. The system of claim 1, wherein behavioural profiler is configured to calculate one or more features to represent each server, task or user of the data centre utilisation information, the features including one or more of:
a submission rate, representing the number of tasks submitted by a user per hour;
a requested amount of compute element per task, and/or
a requested amount of memory per task.

9. The system of claim 1, wherein the utilisation predictor comprises:
an environment generator, configured to:
generate simulated components of a simulated datacentre based on the data centre policy information and/or infrastructure data, and
generate a simulated workload for the simulated data centre by generating users and/or tasks and/or servers based on the behaviour patterns, and
a simulation engine, configured to execute the simulated workload on the simulated components.

10. The system of claim 9, wherein the utilisation predictor comprises a monitoring unit operable to collect data from the simulated data centre and generate the at least one data centre utilisation metric based on the collected data.

11. The system of claim 1, wherein the at least one data centre utilisation metric is one or more of: CPU load; temperature; cooling cost; throughput and/or an energy efficiency metric.

12. The system of claim 1, wherein the infrastructure data comprises one or more of:
information of physical components of the data centre;
power system data;
virtual and software data.

13. The system of claim 1, wherein the data centre policy information and/or infrastructure data is defined recursively, so that elements of data centre policy information and/or infrastructure data are defined at varying levels of detail.

14. A computer-implemented method of forecasting data centre utilisation, comprising:
determining a plurality of virtual behaviour patterns by analysing data centre utilisation information;
specifying infrastructure data representing hardware and/or software components of a data centre; and
calculating at least one data centre utilisation metric based on the determined virtual behaviour pattern, data centre policy information and/or the infrastructure data.

15. A non-transitory computer-readable medium comprising:
a memory area having instructions recorded thereon which, when executed, cause a computing device to forecast data center utilization by:
determining a plurality of virtual behaviour patterns by analysing data centre utilisation information;
specifying infrastructure data representing hardware and/or software components of a data centre; and
calculating at least one data centre utilisation metric based on the determined virtual behaviour pattern, data centre policy information and/or the infrastructure data.

16. (canceled)
